(19) United States
(12) Patent Application Publication
(10) Pub. No.: US 2025/0083403 A1
(43) Pub. Date: Mar. 13, 2025

(54) IN MOLD PAINTING OF LIGHTWEIGHT CORE STRUCTURE ASSEMBLY WITH VEHICLE EXTERIOR SURFACE FINISH

(71) Applicant: Teijin Automotive Technologies, Inc., Auburn Hills, MI (US)

(72) Inventors: Hugh Foran, Auburn Hills, MI (US); Matthew Plauman, Auburn Hills, MI (US); Evan Freeman-Gibb, Auburn Hills, MI (US)

(73) Assignee: Teijin Automotive Technologies, Inc., Auburn Hills, MI (US)

(21) Appl. No.: 18/806,806

(22) Filed: Aug. 16, 2024

Related U.S. Application Data
(60) Provisional application No. 63/536,946, filed on Sep. 7, 2023.
(60) Provisional application No. 63/538,351, filed on Sep. 14, 2023.
(60) Provisional application No. 63/547,725, filed on Nov. 8, 2023.

(51) Int. Cl. B32B 3/12; B29C 43/18; B29C 43/20; B29C 43/56; B29L 31/30; B32B 3/08; B32B 5/02; B32B 5/18; B32B 5/24; B32B 7/02; B32B 7/12; B32B 27/12; B32B 27/20; B32B 27/40

(52) U.S. Cl. CPC B32B 3/12; B29C 43/18; B29C 43/203; B29C 43/56; B32B 3/08; B32B 5/022; B32B 5/024; B32B 5/18; B32B 5/245; B32B 7/02; B32B 7/12; B32B 27/12; B32B 27/20; B32B 27/40; B29C 2043/561; B29C 2793/0027; B29C 2793/009; B29L 2031/3005; B32B 2255/26; B32B 2262/101; B32B 2307/4023; B32B 2307/406; B32B 2307/41; B32B 2307/538; B32B 2307/7246; B32B 2307/7376; B32B 2605/003; B32B 2607/00

(57) ABSTRACT

A composite sandwich panel structure is provided with a lightweight core sandwiched between a high gloss surface sheet and an optically uniform painted or otherwise finished structural skin that are adhered to the lightweight core so as to reduce delamination of the formed part. The structural skin is surface finished during the formation of the sandwich panel structure and does not require any post manufacturing finishing steps such as a separate painting step or material application step. The sandwich composite structure, the high gloss surface sheet, and structural skin are adhered to the lightweight core with an adhesive or glue that is viscous when applied. The viscosity of the adhesive as applied allows for contact with the interior volume of the lightweight core to create more adhesion surface area yet without excessively running into the pores defined in the lightweight core before the adhesive cures or hardens.

### RELATED APPLICATIONS

This application claims priority of U.S. Provisional Patent Application Ser. Nos. 63/536,946, filed Sep. 7, 2023, 63/538,351, filed Sep. 14, 2023, and 63/547,725, filed Nov. 8, 2023, respectively; the contents of which are incorporated herein by reference.

### FIELD OF THE INVENTION

The present invention in general relates to composites and in particular to a composite sandwich structure assembly with an intervening lightweight core support matrix and surface sheets adhered to the lightweight core to provide at least one surface that meets vehicle exterior surface gloss standards and at least one vehicle interior surface that includes a polyurethane (PU) paint or other surface finish without resort to post-production painting or finishing operations.

### BACKGROUND OF THE INVENTION

Weight savings in the automotive, transportation, and logistics-based industries has been a major focus in order to make more fuel efficient vehicles both for ground and air transport. In order to achieve these weight savings, light weight composite materials have been introduced to take the place of metal structural and surface body components and panels. Composite materials are materials made from two or more constituent materials with significantly different physical or chemical properties, that when combined, produce a material with characteristics different from the individual components. The individual components remain separate and distinct within the finished structure. A composite material may be preferred for many reasons: common examples include materials which are stronger, lighter, or less expensive when compared to traditional materials. A sandwich-structured composite is a special class of composite material that is fabricated by attaching two thin but stiff skins to a lightweight but thick core. The core material is normally a low strength material, but its higher thickness provides the sandwich composite with high bending stiffness with overall low density.

While sandwich structures have previously been developed to provide strength and reduced weight, the ability to obtain a vehicle exterior quality high gloss surface has remained a challenge, regardless of whether the surface outermost layer is thermoset resin or thermoplastic. Exemplary of these efforts are U.S. Pat. Nos. 5,087,500A; 4,803,108A; 8,091,286B2; 4,369,608A; 3,553,054A; and WO2018/202473. It is conventional to either not use such structures in settings where a vehicle high surface gloss is required, or resort to an additional outer layer to provide a high gloss outermost layer. Such outermost layers can be applied after structure production or through in-mold coatings, both of which add to the cost and complexity of production.

Additional issues associated with sandwich structures include the need for post-formation finishing steps, including for example painting of the sandwich structure, which adds cost and complexity to the production thereof as well as an increased amount of scrappage given that it is well understood in manufacturing industries that with each additional step in the manufacturing process there is some waste and scrap associated therewith. Therefore, eliminating a step from the production or postproduction of a manufactured good reduces the waste and scrap thereof, thereby reducing manufacturing costs and time. While some attempts have been made to provide a painted layer on sandwich structures, existing solutions fail to produce a paint layer that is optically uniform across the layer of the sandwich structure. Instead, such paint layers tend to thin out and become translucent in various areas of the sandwich structure, particularly those areas where contours may be present.

Still another problem conventional to the art is that structure edges are ineffective and allow for infiltration of humidity or moisture that becomes entrained within the core and often inconsistent with finished vehicle surface requirements. With temperature extremes this entrained moisture can reduce the operational lifetime of the structure, while increasing the weight thereof. These problems of moisture infiltration are particularly pronounced in instances when the core is formed of cellulosic materials such as paper.

Thus, there exists a need for a sandwich composite structure that affords a high gloss vehicle exterior surface and a finished vehicle interior surface that has optical uniformity without resort to additional processing after production or the addition of further outermost surface layers. There also exists a need for such sandwich composite structures with moisture resistance and well-trimmed edges

### SUMMARY OF THE INVENTION

A composite sandwich panel assembly is provided. The composite sandwich panel assembly includes a lightweight core having a first face and a second face opposing the first face, a high gloss surface sheet adhered to the first face of the lightweight core by a first adhesive layer, the high gloss surface sheet having a high gloss surface, a structural skin adhered to the second face of the lightweight core by a second adhesive layer, and a paint layer disposed on an exposed surface of the structural skin, the layer exhibiting optical uniformity over at least 80% of the surface area of the layer.

A process is provided for forming a composite sandwich panel assembly. The process includes applying paint layer precursors to a surface of a mold in which the composite sandwich panel assembly is to be formed and allowing the paint layer precursors to at least partially cure to form a layer, positioning an exposed surface of a structural skin in the mold on the layer, joining a first face of a lightweight core to a surface of the structural skin that is opposite the paint layer with a first adhesive layer intermediate therebetween, and joining a high gloss surface sheet to a second face opposing the first face of the lightweight core with a second adhesive layer intermediate therebetween to form the composite sandwich panel assembly

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a partial cutaway, perspective view of an inventive composite sandwich assembly with a simple edge;

FIG. 2 is an enlarged partial cutaway, side view of a composite sandwich assembly of FIG. 1 along a line bisecting the hexagonal pores;

FIGS. 3A-3F are top views of various open pore structures operative in the present invention that include hexagonal (FIG. 3A), circular (FIG. 3B), rhomboidal (FIG. 3C), triangular (FIG. 3D), parallelogram quadrilateral (FIG. 3E), and regular quadrilateral (FIG. 3F);

FIGS. 4A-4D are cross-sectional views of edges according to the present invention;

FIG. 5 is a partial cutaway, perspective view of composite sandwich assembly having a conduit system embedded therein according to embodiments of the present disclosure;

FIG. 6 is a partial cutaway, perspective view of an inventive composite sandwich assembly with a foam lightweight core with a simple edge;

FIG. 7 is an enlarged partial cutaway, side view of a composite sandwich assembly of FIG. 6;

FIG. 8 is a partial cutaway, perspective view of composite sandwich assembly with a foam lightweight core having a conduit system embedded therein according to embodiments of the present disclosure; and

FIG. 9 is a molding curve of pressure and temperature as a function of time for an exemplary composite sandwich assembly according to the present invention.

### DESCRIPTION OF THE INVENTION

The present invention has utility as a composite sandwich panel structure with a lightweight core sandwiched between a high gloss surface sheet and an optically uniform painted or otherwise finished structural skin that are adhered to the lightweight core so as to reduce delamination of the formed part. Notably, the structural skin is surface finished during the formation of the sandwich panel structure and does not require any post manufacturing finishing steps such as a separate painting step or material application step. According to embodiments of the inventive sandwich composite structure, the high gloss surface sheet and structural skin are adhered to the lightweight core with an adhesive or glue that is viscous when applied. The viscosity of the adhesive as applied allows for contact with the interior volume of the lightweight core to create more adhesion surface area yet without excessively running into the pores defined in the lightweight core before the adhesive cures or hardens thereby providing greater adhered contact area between the components of the inventive sandwich composite structure. As a result, reduced delamination of the components of the inventive sandwich composite structure is observed as well as precluding bond line readthrough into the high gloss surface sheet. It is appreciated that providing a high gloss exterior surface without resort to an additional outmost layer requires a balancing of opposing surface tension properties of the inventive composite sandwich panel structures to avoid a loss in tolerances associated with bowing of the structure. In some embodiments of the present invention, a cloth is positioned intermediate between the lightweight core and at least one of the high gloss surface sheet or the structural skin. Embodiments of the present invention also have utility as watertight and waterproof composite sandwich panel structures.

The present invention is suitable for all vehicle components made of composite material, but in particular for vehicle body shell components, such as vehicle roof modules, roof posts, A, B, C or D pillars of vehicles, vehicle doors, wings, engine compartment covers, luggage compartment covers, rear-end modules, roof shells of cabriolet hoods, front or rear spoilers. Embodiments of the present invention further provide sound dampening and temperature variation resistance qualities.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

As used herein, the term “high gloss surface” refers to a surface having minimal perceptible surface defects when visually inspected for about three seconds from about 24-28 inches from the viewer and normal to the part surface +/−90 degrees in a well-lit area. That is, the term “high gloss surface” refers to a surface capable of being painted and accepted as a “Class A” autobody part. This is commonly measured by ASTM D523. In the automotive industry, a Class A surface is a surface a consumer can see without functioning the vehicle (e.g., opening the hood or decklid), while a Class A surface finish generally refers to painted outer panels and specifically to the distinctness of image (DOI) and gloss level on the part. It is appreciated that a surface layer may be subjected to sanding, trimming, and priming prior to receiving a paint coating that imparts high gloss, yet must retain dimensionality and adhesion uniformity to primer and paint so as to achieve a high gloss finish.

As used herein, “optical uniformity” refers to the appearance of the paint layer precursors forming a paint layer 29 of the composite sandwich panel 10. Notably, to be optically uniform the appearance of the paint layer 29 must be uniform and consistent over at least 80% of the surface area of the paint layer 29. According to embodiments, the appearance of the paint layer 29 is uniform and consistent over the entire surface area of the paint layer 29 but for any portion of the part that is to be cut off or otherwise removed. In particular, to be optically uniform, the paint layer 29 includes no color variations over the part. The optical uniformity is determined by a visual inspection preformed at an approximate distance of 600 mm (approximate arm's length) from the observer, normal to the part surface +/−90 degrees. Any person appraising color must be tested for the absence of color blindness and demonstrate color acuity per ASTM-E 1499. In the inspection area, the light intensity shall be 80 to 125 maintained foot-candles. The Inspection Area shall comply with SAE J361. Additional applicable standards referred to for evaluating optical uniformity include ASTM E284, Standard Terminology of Appearance; ASTM E1499—Standard Guide to the Selection, Evaluation, and Training of Observers; and SAE J361—Procedure for Visual Evaluation of Interior and Exterior Automotive Trim.

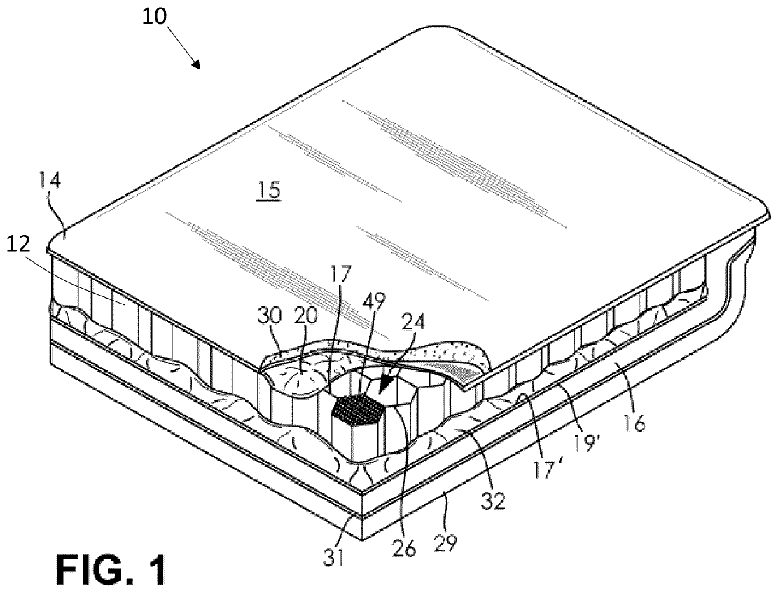

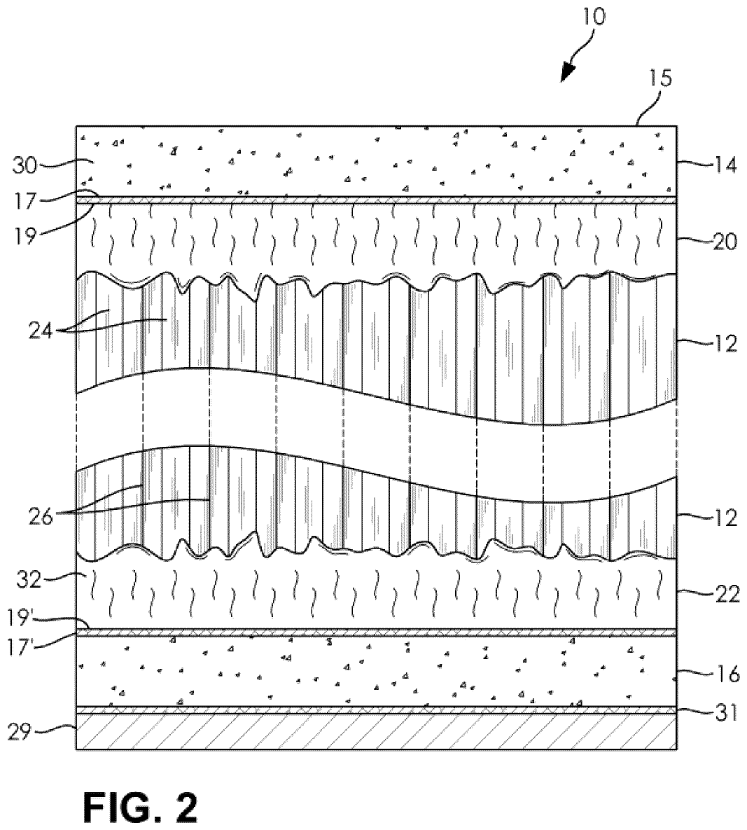

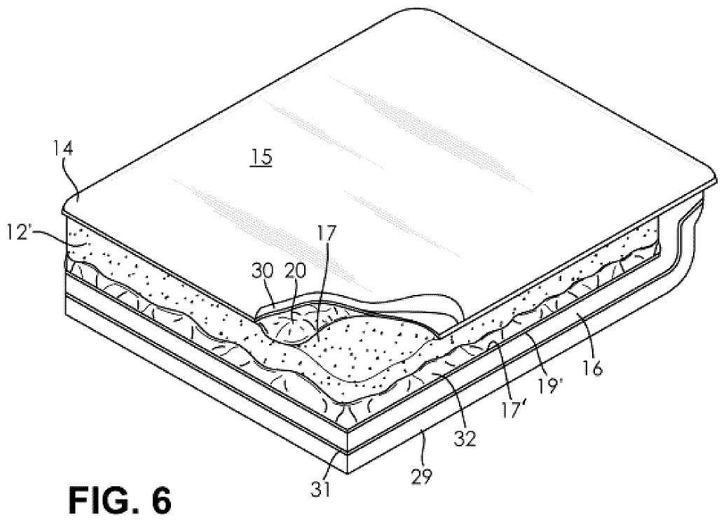

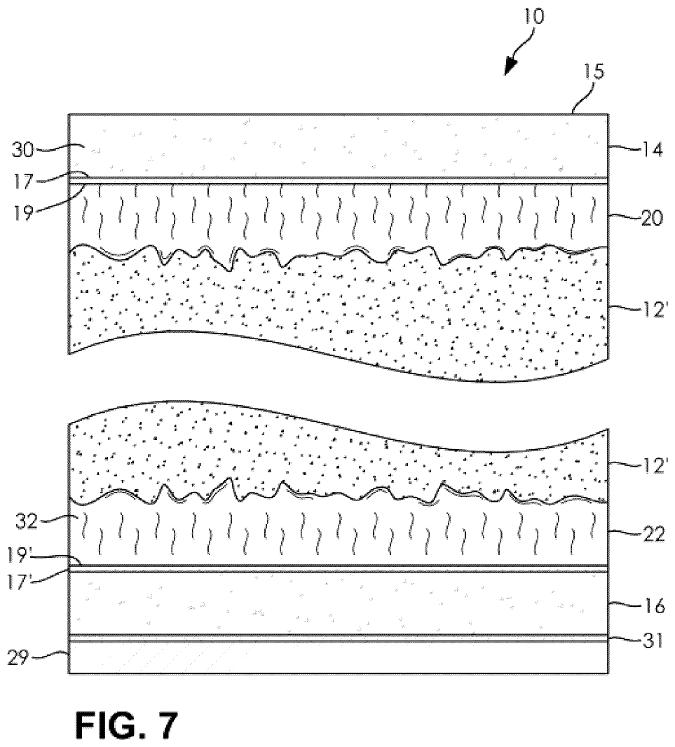

Referring now to the figures, an inventive composite sandwich, shown generally at 10. The sandwich 10 has a lightweight core 12, 12′ terminating in faces 17 and 17′. According to embodiments, the lightweight core 12′12 is a foam material, which may be custom molded to suit the particular design requirements of an inventive composite sandwich application, as shown in FIGS. 6-8. According to other embodiments, the lightweight core 12 includes walls 26 defining an ordered array of pores 24 terminating in faces 17 and 17′. The lightweight core 12 is positioned between a high gloss surface sheet 14 on one side and a structural skin 16 on an opposite side therefrom. As shown in FIGS. 1 and 6, a portion of the high gloss surface sheet 14 is cutaway to reveal the adhesive 20, a cloth, if present; and the lightweight core 12, 12′. The high gloss surface sheet 14 is adhered to a first side of the lightweight core 12, 12′ by a first adhesive layer 20 and presents an outwardly facing high gloss surface 15. FIGS. 2 and 7 are an enlarged cross-sectional view of a composite sandwich 10 according to embodiments of the invention showing further details of the various layers making up the composite sandwich. In some inventive embodiments, a cloth 19 is present intermediate between the face 17 of the lightweight core 12, 12′ and the high gloss surface sheet 14, the cloth 19 embedded within the adhesive 20. The structural skin 16 is adhered to an opposing second side of the lightweight core 12 by a second adhesive layer 22. In some inventive embodiments, a cloth 19′ is present intermediate between the face 17′ of lightweight core 12 and the structural skin 16, the cloth 19′ embedded within the adhesive 22. While the structures 10 depicted in is the figures are planar, it is appreciated that both the high gloss surface and the structure surface are each independently formed with non-planar contours.

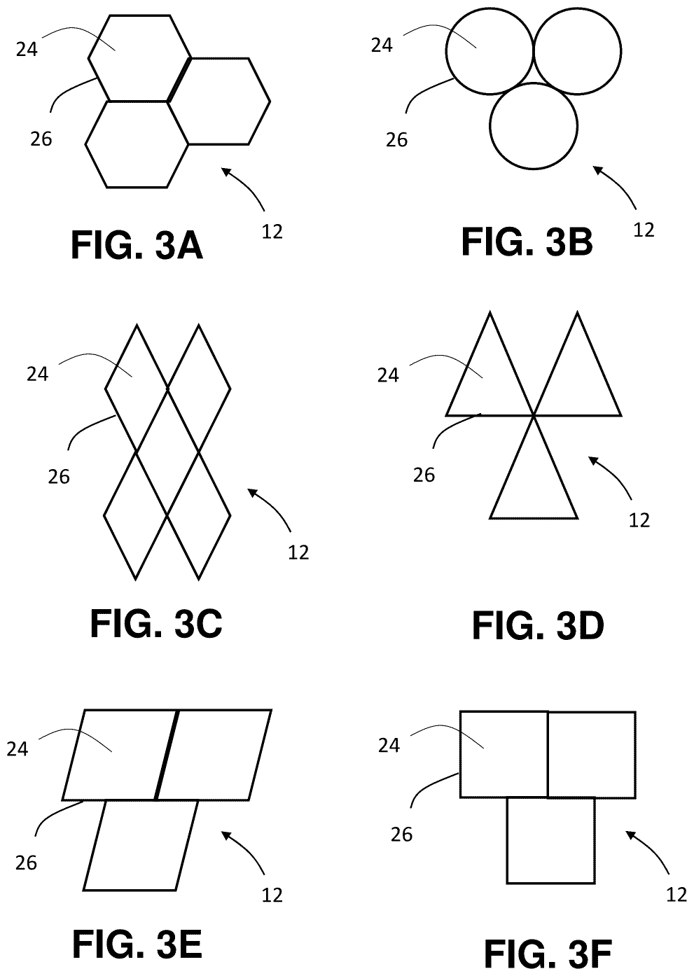

FIGS. 3A-3F show in top view of the edges of walls 26 that define pores 24 in certain embodiments of the lightweight core such as 12 depicted in FIGS. 1 and 2. An lightweight core, such as 12 depicted with respect to FIGS. 1 and 2 may use a wall material 26 to define a plurality of pores 24 in shapes that illustratively include hexagonal (FIG. 3A), circular (FIG. 3B), rhomboidal (FIG. 3C), triangular (FIG. 3D), parallelogram quadrilateral (FIG. 3E), and regular quadrilateral (FIG. 3F). of honeycombs, diamonds, squares, triangles, parallelograms, circles, or a combination thereof. The faces 17 and 17′ of the lightweight core 12 support the tensioned high gloss surface sheet 14 and structural skin 16 when the inventive composite sandwich is assembled and transfer externally applied forces within the structure 10. It is appreciated that while pores are depicted as isolated from one another that wall structures are readily formed from extended folded strips that define a portion of several pores and when made contiguous with other such folded strips define an array of pores that are intercommunicative along the lines of contact between contiguous strips.

A lightweight core, such as that depicted at 12 is formed of a lightweight material that defines a plurality of pores 24, or cells in a lightweight foam core material, so as to reduce the overall density of the lightweight core 12, 12′. An lightweight core 12, 12′ according to the present invention is formed from a variety of materials that include cellulosics such as corrugated fiberboard, paper board, paper stock; thermoplastics such as poly(methyl methacrylate) (PMMA), acrylonitrile butadiene styrene (ABS), polyamides, polylactides, polybenzimidazoles, polycarbonates, polyether sulfones, polyethylene, polypropylene, polystyrene, polyvinyl chloride, and block copolymers of any one of the aforementioned where at least one of the aforementioned makes up the majority by weight of the copolymer and regardless of the tacticity of the polymer or copolymer; thermosets such as polyesters, polyureas, polyurethanes, polyurea/polyurethanes, epoxies, vinyl esters; metal such as aluminum, magnesium, and alloys of any one of the aforementioned where at least one of the aforementioned metals constitutes the majority by weight of the alloy; a foam or machine cut foam formed from polyurethane, polyethylene, ethylene vinyl acetate, polypropylene, polystyrene, polyvinyl chloride, oraerogels, regardless of whether the foam is open-celled or closed-celled.

According to some inventive embodiments, the pores 24 defined by walls 26 of the lightweight core 12 extend between faces 17 and 17′. In some embodiments, the walls 26 are treated to modify a property thereof such as hydrophobicity or surface energy to promote adhesion thereto. By way of example, cellulosics are prone to moisture uptake and are readily coated with a wax such as a paraffin, or a silicone to render the cellulosic more hydrophobic compared to a native state. Alternatively, the cellulosic is readily alkylated by conventional reactions such as those with chloroacetic acid. Sarymsakov, A. A et al., Chem. Nat. Compd. (1997) 33:337. Metals are similarly coated with a primer or other corrosion inhibitor. Alternatively, metals or polymers are plasma treated to modify surface energies to facilitate adhesion thereto.

In certain inventive embodiments, the ratio of the thickness of a wall 26 to the maximal linear extent between faces 17 and 17′ is between 0.01-10:1. A wall thickness ranges from 0.1 mm to 100 mm in such inventive embodiments.

A high gloss surface sheet according to the present invention and as shown for example with respect to reference numeral 14 is formed from sheet molding compound (SMC), thermoplastic, dicyclopentadiene (DCPD), overmolded polyurethane (PU), or a combination thereof. According to embodiments, the high gloss surface sheet 14 includes a filler material 30 to reinforce and/or serve to decrease the weight of the high gloss surface sheet 14. The filler material 30 is any of glass fibers, carbon fibers, natural fibers, hollow or solid glass microspheres, or a combination thereof. The fibers may be oriented or non-oriented. In some inventive embodiments in which SMC forms the high gloss surface, a resin package sold by Tejiin Automotive Technologies, Inc. under the tradenames TCA®, TCA® ULTRA-LITE™, TCA® FLOAT® are used herein. Exemplary formulations of which are detailed in U.S. Pat. No. 7,700,670; WO2017/184761; and U.S. Pat. No. 7,524,547B2 and have densities as low as 0.8. It is appreciated that the high gloss sheet routinely includes additives to retain dimensionality. Such additives routinely including glass fiber; carbon fiber; inorganic particulate fillers such as calcium carbonate, talc, and carbon black; glass microspheres; carbon nanotubes; graphene; low profile additives; moisture scavengers; and combinations thereof. Typical thicknesses of the high gloss surface sheet in the present invention range from 0.5 to 5 millimeters (mm) without regard to edges.

A high gloss surface sheet such as that depicted in 14 is adhered to a first side of the lightweight core 12, 12′ by a first adhesive layer 20. The first adhesive layer 20 is formed of either a thermoplastic or curable formulation. According to certain inventive embodiments, the first adhesive layer 20 is a polyurethane or polyurethane prepolymer adhesive, which may be in the form of glue, a moisture cure adhesive, a reactive hot melt adhesive, or a polyurethane resin. As shown in FIG. 2, due to the compressive force applied to the first adhesive layer 20 between the high gloss surface sheet 14 and the lightweight core 12, the adhesive 20 is engineered to have an initial viscosity on contact with the face 17 and the walls 26 so as partially fill the pores 24 of the lightweight core 12. It is appreciated that the viscosity upon application is a function of factors that include application temperature, pore dimensions at the face, and intrinsic adhesive viscosity. The viscosity of the first adhesive layer 20 ensures that the adhesive does not excessively run into the pores defined in the lightweight core 12 before the adhesive attains final strength. Accordingly, the adhesive surface area for adhesion between a high gloss surface sheet and a lightweight core is at least 5% more than surface area of the walls at the face. In still other embodiments, the adhesive area is between 5 and 100 surface area percent of the face, and even 100 surface area percent in still other inventive embodiments. This increased surface area of adhesion reduces delamination of the components of the inventive composite sandwich 10 and surprisingly allows for the use of thinner high gloss surface sheets that do not exhibit bond line read through. As a result of increasing the adhesive surface area coverage from 10 to 50 surface areas percent allows for the comparatively expensive high gloss surface sheet to be reduced in thickness from 1.5 mm to between 1.3 and 0.8 mm while still retaining high gloss through prevention of bond line read through.

As will be understood by a person having ordinary skill in the art, the high gloss surface sheet tends to be a comparatively dense component and an expensive portion to manufacture given the materials used and necessary forming processes to maintain minimal perceptible surface defects suitable for a Class A autobody part. To reduce costs and weight of the inventive composite sandwich panel assembly 10, it is accordingly desirable to reduce the thickness of the high gloss surface sheet 14, making it as thin as possible. It will also be understood that as the thickness of the high gloss surface sheet 14 is decreased the high gloss surface sheet 14 tends to deform when supported by limited portions of the face 17 above the lightweight core 12, 12′. While result to a large contact surface area of the first adhesive layer 20 is advantageous, in some inventive embodiments a cloth 19 is embedded in the first adhesive layer 20.

The cloth can be woven or nonwoven yet having sufficient porosity to allow the adhesive layer 20 to penetrate therethrough. The cloth 19 providing not only a larger surface area for adhesive layer 20, but also the cloth is believed to function to mitigate surface tension differences relative to structural layer 16 associated with situations such as the manufacturing process, temperature differences in a use environment, and differential force loading during usage. A cloth 19 operative herein illustratively includes fibers of thermoplastic materials such as poly(methyl methacrylate) (PMMA), acrylonitrile butadiene styrene (ABS), polyamides, polylactides, polybenzimidazoles, polycarbonates, polyether sulfones, polyethylene, polypropylene, polystyrene, polyvinyl chloride, and block copolymers of any one of the aforementioned where at least one of the aforementioned makes up the majority by weight of the copolymer and regardless of the tacticity of the polymer or copolymer; carbon fibers; polyaramids; glass fibers in the form as a woven, roving, or lofted sheet; and mixtures of the various fibers. The cloth 19 has a mesh size of 10 to 1000, that is, the mesh layer has 10 to 1000 opening per square inch. The cloth 19 tends to reduce the effects of the walls 26 on the outward appearance of the high gloss surface sheet 14.

The structural skin 16 is adhered to the second side of the lightweight core 12, 12′ by a second adhesive layer 22. The structural skin 16 is formed of a fiber mat, a thermoplastic sheet, or an SMC. In some embodiments the SMC is also a high gloss surface as detailed above with respect to reference numeral 14. In inventive embodiments where the structural skin 16 is a fiber mat, the fiber mat is formed of glass fibers. According to certain inventive embodiments, the fiber mat forming the structural skin includes non-oriented, non-woven fibers, unidirectional, or woven fibers. The structural skin 16 is adhered to the second side of the lightweight core 12, 12′ by a second adhesive layer 22. The second adhesive layer 22 having the attributes of the first adhesive layer detailed above with respect to reference numeral 20. In some inventive embodiments, the same adhesive forms both first adhesive layer 20 and second adhesive layer 22. In still other inventive embodiments, a cloth 19′ is present within the second adhesive layer 22, the cloth 19′ having the attributes of the cloth 19 as detailed above. In some inventive embodiments where both cloths 19 and 19′ are present, the cloths 19 and 19′ are formed of the same material. In still other embodiments, the cloths 19 and 19′ are formed of the same material and have the same thickness. In still other embodiments, the cloths 19 and 19′ are formed of the same material, have the thickness, and are adhered by the same adhesive. In still other embodiments, the surface tension on the high gloss surface sheet 14 and the structural skin 16 are within 10% of one another. In some inventive embodiments, the structural skin 16 terminates against the backside of the high gloss surface sheet 14 to encapsulate the lightweight core 12, 12′.

According to embodiments, the thickness of the lightweight core 12, 12′, the high gloss surface sheet 14, and the structural skin may vary based on design parameters and intended use of a finished component formed from a composite sandwich panel assembly 10 of the present disclosure. As noted above, the present disclosure provides a high gloss surface sheet 14 having a thickness of 0.5 to 3.5 mm. The ratio of the high gloss surface sheet 14 average thickness to the lightweight core 12, 12′ average thickness is 0.01-1:1, while the ratio of the structural skin 16 thickness to the lightweight core 12, 12′ thickness is 0.05-1:1. In a particular inventive embodiment, the high gloss surface sheet 14 has an average thickness of 1.5 to 5 mm and the lightweight core 12, 12′ has an average pore or void diameter of 6 to 25 mm. In some inventive embodiments, the lightweight core 12, 12′ pore or void diameter is as much as 42 mm. As used herein, pore or void diameter is defined as the average of orthogonal pore or void dimensions measured at a right angle to the pore or void axis at the interior wall edge at the face 17. By way of example, a circular pore or void has identical diameter in x- and y-directions relative to the pore axis.

According to inventive embodiments, a decorative paint layer 29 is applied to the exposed surface of the structural skin 16, that is the surface that is opposite the lightweight core 12, 12′. In some embodiments, the paint layer 29 applied to the structural skin 16 is configured to be a vehicle interior surface. According to embodiments, the paint layer 29 imparts any color to the structural skin 16, including black, grey, beige, or white. According to embodiments, the paint layer 29 imparts a tactile feel to the structural skin 16, for example a felted material feel or a rubber grip feel. According to embodiments, the paint layer 29 is optically uniform even across three-dimensional contours of the composite sandwich panel assembly 10. According to embodiments, the paint layer 29 is entirely opaque across at least 80% of the surface area of the paint layer 29, ensuring that the even when viewed by an unaided human eye from a close proximity of at 12 inches, the structural skin 16 and the interior components of the sandwich panel including the adhesive layer 22 and the lightweight core 12, 12′ are not visible through the paint layer 29. According to embodiments, the paint layer 29 is up to 150 microns thick. According to embodiments, a veil 31 is positioned between the structural skin 16 and the paint layer 29. According to embodiments, the veil 31 is pre-painted or otherwise provided with a color, such as white in order to further enhance the optical uniformity of the paint layer 29. As will be described below, the decorative paint layer is applied to the structural skin 16 in the mold as the composite sandwich panel assembly 10 is formed therein. This is advantageous given that this eliminates the need for post formation finishing steps, including for example sanding and painting of the interior surface of the sandwich structure, thereby reducing cost and complexity to the production thereof as well as reducing waste and scrappage that tends to occur with painting errors and additional finishing mistakes. According to embodiments, the paint layer 29 includes a textured outer surface that is imparted to the paint layer 29 by the mold during the application process.

According to embodiments, the paint layer 29 is a polyurethane paint. According to embodiments, the paint layer 29 is provided as precursors of an oil-in-water emulsion. The paint layer 29 precursors operative herein are formed of polyurethanes, latexes, epoxies, polyureas, polyacrylates, or block co-polymers in which any of the aforementioned constitute at least 20 percent of the total number of subunits. According to embodiments, the paint layer 29 is formed of a one or two part polymeric system, with one part preferably being water based. It is appreciated that the paint layer 29 precursors readily contain a pigment, dye, or ink to impart any desired color to the paint layer 29. According to embodiments, the structural skin 16 is formed of a polyurethane material that is pigmented, dyed, or colored with an ink so that the paint layer 29 is integrally formed with the structural skin 16. For example, a polyurethane material for forming the structural skin 16 can be provided with a pigment, dye, or ink incorporated therein to color the polyurethane material. For example, such a dye may be an oil-based dye for coloring the polyurethane. According to such embodiments, the dye is typically present from 0.5 to 5 total mixed weight percent of the polyurethane material. Exemplary colors include white, gray, yellow, red, blue, beige, and black; each paint layer 29 being smooth, textured, or a combination thereof and being complementary to the mold surface. According to embodiments, the paint layer 29 is applied to the structural skin 16 as a powder-in-mold-coating. In such embodiments, a highly reactive powder paint is applied to a surface of the mold in which the composite sandwich structure assembly is to be formed. The mold may be preheated prior to application of the powder coating, or it can be heated after application of the powder thereto. Upon heating of the mold, the powder immediately begins to gel. Then the structural skin 16 material is applied thereto, and additional layers of the composite material assembly are applied thereto and molded. The resulting assembly can be demoulded as a finished coated component after pressing. This one-step process is compatible with all common release agents and enables resistant surfaces in Class A, high gloss quality. According to embodiments, the paint layer 29 includes at least one additive used to modify and enhance the appearance and longevity of the paint layer 29. That is, according to embodiments, the polyurethane paint that forms the paint layer 29 includes at least one of UV stabilizers to impart UV resistance to the paint layer 29, mica to impart sparkle to the paint layer 29, and a phosphorescent material to impart a glow-in-the-dark appearance to the paint layer 29. For example, the phosphorescent material may be a red phosphorescent given the low cost of red phosphorescent materials and given that the red glow imparted by such phosphorescent does not impair night sight.

According to certain inventive embodiments, the composite sandwich panel assembly provides sound damping, fire retardancy, thermal insulation, or a combination thereof by placing a sound and/or heat absorbing material within the pores 24 of the lightweight core 12. According to embodiments, the pores 24 of the lightweight core 12 are at least partially filled with a fill 49, as shown in FIG. 1. The fill illustratively including foam pellets, fire retardant, or a phase change material. Phase change materials operative herein include waxes or an inorganic salt hydrates.

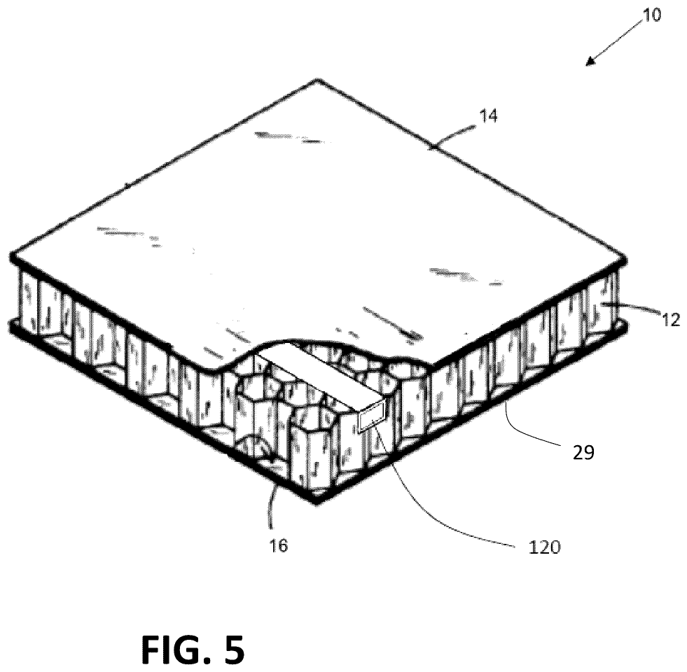

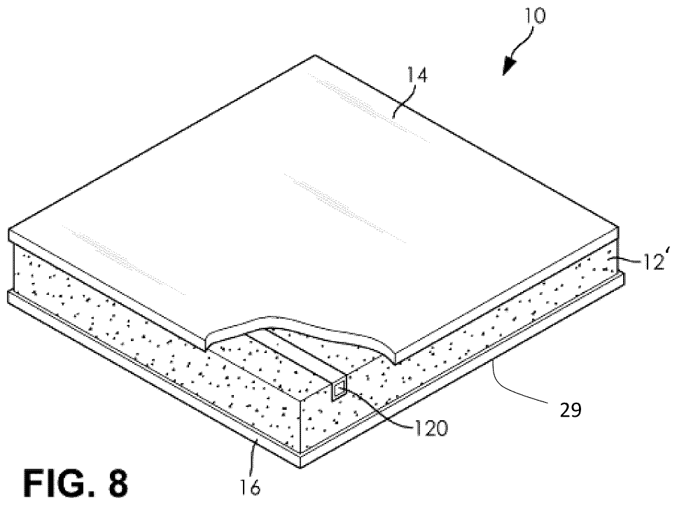

According to embodiments, the composite sandwich panel assembly 10 includes a fastener or a conduit system 120 embedded within the lightweight core 12, 12′. As shown in FIGS. 5 and 8, the conduit system 120 is embedded in the composite sandwich panel assembly 10 and includes tubing or wires that are molded into the lightweight core 12, 12′ of the composite sandwich. According to embodiments, the conduit system 120 includes electrical wiring, ventilation ducts or conduits, or heating elements. Accordingly, features such as speakers, lights, air vents for regulating the climate within the vehicle, and defrosting elements for removing ice or snow may be easily installed on the composite sandwich panel assembly 10. According to embodiments the conduit 120 of a first composite sandwich panel assembly 10 are designed to align and connect with the conduit 120 of a second composite sandwich assembly 10 and/or with like electrical wiring, ventilation ducts, and/or heating elements of a vehicle.

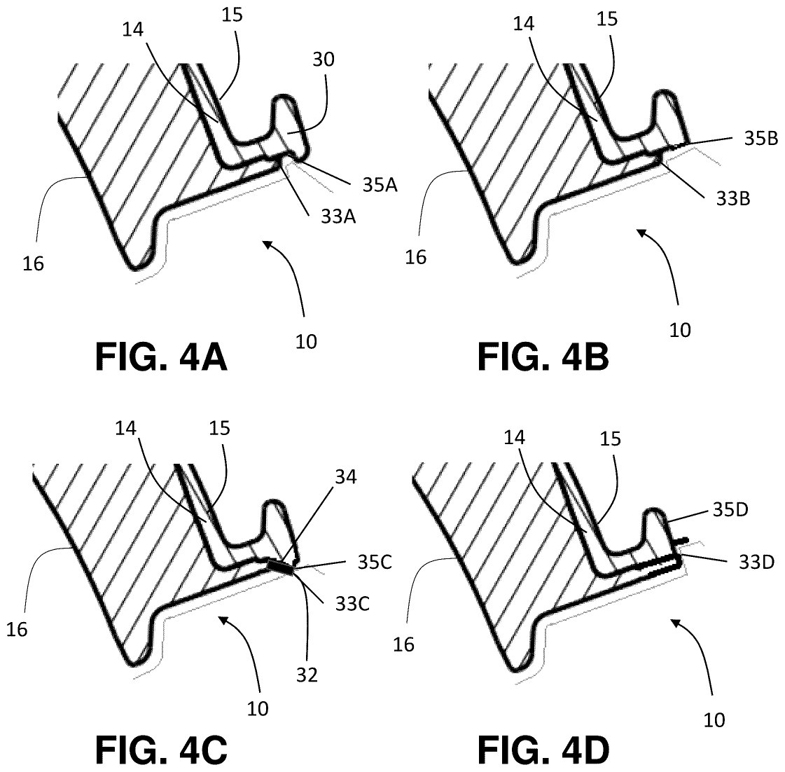

The high gloss surface sheet 14 with outward facing high gloss surface 15 and the structural skin 16 are joined together along an edge 33A-33D of the composite sandwich panel assembly to form a seal, as shown in FIGS. 4A-4D, respectively. In certain inventive embodiments in which all of the edges of the composite sandwich panel assembly 10 are sealed, the lightweight core 12, 12′ is fully enclosed and moisture is inhibited from entering the interior of the composite sandwich panel assembly 10. In some situations, depending on the intended use and location of a part formed of the composite sandwich panel assembly 10, preventing moisture from entering the interior of the composite sandwich panel assembly 10 is important given that freeze thaw cycles of moisture within the part cause expansion and potentially failure of the assembly 10. Additionally, in embodiments in which the lightweight core 12, 12′ is formed of a hydrophilic material such as paper, moisture within the composite sandwich panel assembly 10 would destroy the lightweight core 12, 12′ and cause the part to fail.

FIGS. 4A-4D show various embodiments of ways in which the high gloss surface sheet 14 and the structural skin 16 are joined together to form a sealed edge 33A-33D, respectively according to the present disclosure. In some inventive embodiments an elastomeric gasket 34 is disposed between the high gloss surface sheet 14 and the structural skin 16 at the 33C to make the edge 33C more water resistant. It is appreciated that a gasket is readily included in the other edge joinder 33A, 33B, and 33D. The gasket 34 enhances maintenance of the edge seal over a wider range of use conditions.

As will be understood by one having ordinary skill in the art, to form an edge seal between the high gloss surface sheet 14 and the structural skin 16, at least one of the high gloss surface sheet 14 and the structural skin 16 requires enough material to wrap around the edge of the composite sandwich 10. According to certain inventive embodiments, at least one of the high gloss surface sheet 14 and the structural skin 16 is provided in dimensions greater than the dimensions of the final composite part such that the material is able to wrap around the final edge composite sandwich 10. According to certain inventive embodiments, the at least one of the high gloss surface sheet 14 and the structural skin 16 is preformed such that it has edges extending generally perpendicularly from the plane of the sheet material.

According to certain inventive embodiments, excess material is cut from the composite sandwich once the edge seal is formed. As shown in FIG. 4A, excess material of the structural skin 16 has been trimmed from the composite sandwich assembly 10 by a knife or router that presses against the divot 35A that is formed by the high gloss surface sheet 14. In FIG. 4B, the edge 33B formed by removing excess material for tool engagement against a shoulder 35B of the high gloss surface sheet 14. In FIG. 4C, the edge 33C formed by removing excess material for tool engagement against a shoulder 35C of the high gloss surface sheet 14. Also, as shown in FIG. 4D, excess material of one or both the high gloss surface sheet 14 and the structural skin 16 are trimmed with tool pressure against shoulder 35D.

The present disclosure further provides a process for forming the composite sandwich structure 10 according to embodiments of the invention. A process for forming a composite sandwich panel assembly 10 according to the present invention includes applying a paint layer 29 precursor to a surface of a mold in which the composite sandwich structure 10 is to be formed. According to certain inventive embodiments, the paint layer 29 precursor is applied to the mold surface by a robot that is configured to automatically and evenly apply the layer precursors thereto. The mold surface having a temperature of between room temperature and the maximal molding temperature is sufficient for the layer precursors to dry to form a layer on the mold. The typical maximal temperature of a mold surface for layer precursors application is less than 220 degrees Celsius. In still other embodiments, the layer 29 precursors are present as an oil-in-water emulsion. According to other inventive embodiments, the layer precursors are applied up to a thickness of 50 to 250 microns. According to some inventive embodiments, the mold surface is textured and/or includes three dimensional contours that are to be formed into the composite sandwich panel 10. The paint layer precursors operative herein are formed of polyurethanes, latexes, epoxies, polyureas, polyacrylates, or block co-polymers in which any of the aforementioned constitute at least 20 percent of the total number of subunits. It is appreciated with the paint layer precursors or a veil 31 readily contain pigment or dye to impart any desired color to the paint layer 29. Exemplary colors include white, gray, yellow, red, blue, beige, and black; each paint layer 29 being smooth, textured, or a combination thereof and being complementary to the mold surface. In still other inventive embodiments, the paint layer 29 has a coefficient of linear thermal expansion (CTLE) that is within 30% of the that of the structural skin 16 when no veil is present therebetween.

The paint layer precursors cure essentially upon contact with a heated mold surface, any contours present on the mold surface are evenly coated without the paint layer precursors running or dripping. It will be understood that the cure rate of the paint layer precursors to form paint layer 29 slows as the thickness of the paint layer increases. Accordingly, while the paint layer precursors that are directly applied to the mold surface cures instantaneously, it is appreciated that it may take slightly more time for the paint that is displaced from the mold surface to cure, thereby providing some working time for the additional layers of the sandwich assembly to be applied thereto. For example, during this working time as the paint layer 29 precursors cure, a veil 31, if present, is readily applied thereto or the structural skin 16 can be applied directly thereto. In some inventive embodiments, a mold release is present on the mold surface to facilitate complete transfer of the paint layer 29 from the mold surface to the structural skin 16. The mold release is appreciated to be single usage, semi-permanent, or permanent.

According to embodiments, a veil 31, which according to some embodiments is pre-painted, is then applied to the PU paint layer 29.

According to embodiments, a mask or shield is utilized to prevent the paint layer 29 from being applied to specified areas of the mold surface and/or structural skin 16. According to embodiments, the mask or shield is applied to the mold prior to the paint layer 29 precursors being applied or is applied to the structural skin 16. According to embodiments, the mask or shield is a barrier such as a sacrificial wax that is applied. According to embodiments, the mask of shield is a tape that is applied to the structural skin 16. According to embodiments, the mask or shield is a material such as a stencil that is removably positionable relative to the mold surface to block the paint layer 29 precursors from being applied to specified areas of the mold and therefore not applied to the structural skin 16.

According to some inventive embodiments, structural skin 16 is applied to the veil 31, if present, or to the paint layer precursors 29. In some inventive embodiments, the second adhesive layer 22 is then applied to a reverse side of the structural skin 16. Applying the second adhesive paint layer 22 on to the reverse side of the structural skin 16 is accomplished by spraying or painting an adhesive onto the structural skin 16. In embodiments in which the structural skin 16 is formed of a glass fiber mat, the glass fiber mat structural sheet 16 may be impregnated with the second adhesive layer 22.

In combination with, or instead of applying the second adhesive layer 22 on to the structural skin 16, the second adhesive layer 22 is applied to the face 17′ of the open are core 12. In those embodiments containing a cloth 19′, the cloth is either placed onto the face 17′ before an adhesive application, after adhesive application, or intermediate between initial and overcoating layers of adhesive. Regardless of the process, a cloth 19′ is embedded within the second adhesive layer 22. The face 17′ of the lightweight core 12, 12′ and the reverse (non-layer precursor) side of the structural skin 16 are then brought into contact with the second adhesive layer 22 therebetween and in some instances, the cloth 19′ therein on the second adhesive layer 22. Preferably, any treatment of the lightweight core 12, 12′ to modify hydrophobicity or surface energy has occurred prior to application of the second adhesive layer 22 thereto. If a material is to be placed within the lightweight core 12, 12′, it can be sprayed or injected into the pores are this point in the manufacturing process.

The inventive process continues by applying the first adhesive layer 20 to high gloss surface sheet 14 and positioning the high gloss surface sheet 14 on the first face 17 of the lightweight core 12, 12′. According to embodiments, the first adhesive layer 20 is applied to the high gloss surface sheet 14 by spraying or painting an adhesive onto the high gloss surface sheet 14. In those embodiments containing a cloth 19, the cloth is either placed onto the face 17 before an adhesive application, after adhesive application, or intermediate between initial and overcoating layers of adhesive. Regardless of the process, a cloth 19 is embedded within the first adhesive layer 22 prior to bringing the high gloss surface sheet 14 into contact with the first face 17 of the lightweight core 12, 12′.

As described above, the first adhesive layer 20 and the second adhesive layer 22 include an adhesive that is highly viscous when in an uncured state. According to embodiments, the adhesive is a polyurethane or polyurethane prepolymer. According to embodiments, the composite sandwich panel 10 is baked or has heat applied to it to cure the first adhesive layer 20 and said second adhesive layer 22. In those inventive embodiments inclusive of sound, fire, of heat barrier materials, such materials are typically added to the pores 24 prior to joining the lightweight core 12 to the structural skin 16.

It is appreciated that the relative ordering of joinder between the high gloss surface sheet 14 and the structural skin 16 can be reversed relative to that detailed above, and in still other embodiments, both the high gloss surface sheet 14 and the structural skin 16 are simultaneously joined to the lightweight core 12, 12′. It is further appreciated that the high gloss surface sheet 14 and the structural skin 16 are each independently positioned with outward surface, positions above, below, or laterally displaced relative to the lightweight core 12, 12′ during joinder.

According to embodiments, the inventive process further comprises at least one of compression molding or vacuum molding the composite sandwich panel 10 once the first sheet 14, lightweight core 12, 12′, second sheet 16, adhesive layers 20, 22, and paint layer 29 precursors have been assembled together. Such compression molding and/or vacuum molding forms the composite sandwich panel 10 to a component suitable to use as a vehicle component. According to embodiments, the compression molding and/or vacuum molding is carried out at significantly lower temperatures and pressures than typical molding processes. That is, according to embodiments, the compression molding and/or vacuum molding of the inventive composite sandwich panel 10 with the decorative vehicle interior paint layer 29 applied to the structural skin 16 is performed at a temperature in the range of 200 to 250 degrees F. Not only does this inventive molding process result in energy savings, but it also enhances the resulting composite sandwich panel 10 in that the lower molding temperatures provide enhanced dimensional stability of the composite sandwich panel 10 and reduce the stress and warp of the composite sandwich panel 10. According to embodiments, the compression molding and/or vacuum molding of the inventive composite sandwich panel 10 with the decorative vehicle interior layer 29 applied to the structural skin 16 is performed at a pressure of 60 to 70 psi. The low temperature and low pressure molding conditions of the inventive process additionally enable alternative options for curing the decorative vehicle interior paint layer 29 precursors, including UV cure using light transmitting glass fibers positioned in the mold near the mold surface where the precursor is applied as well as anaerobic cure.

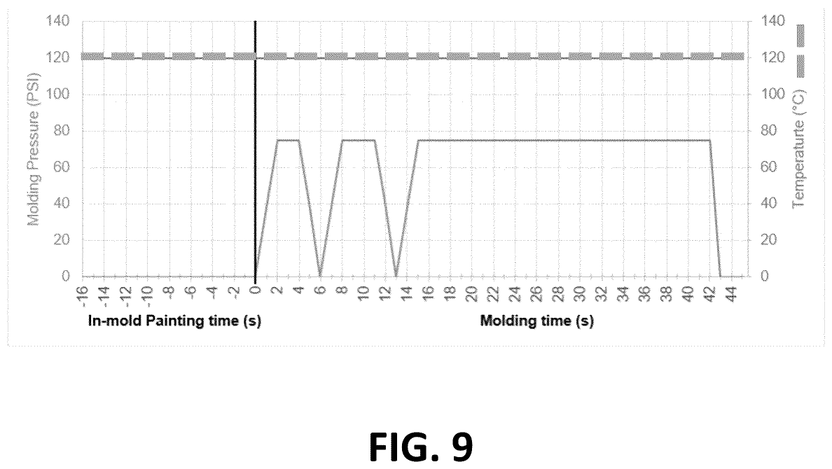

According to embodiments, the compression molding and/or vacuum molding process for forming an inventive composite sandwich panel 10 with a decorative vehicle interior paint layer 29 applied to a structural skin 16 additionally includes a step of opening the mold during the molding step to degas the interior of the mold, that is to allow the off gases formed from the curing of the PU paint layer 29. According to embodiments, this degassing step includes opening the mold slightly after the mold has been closed and the molding pressure and temperature have been achieved. After the degassing occurs, the mold is then closed and the molding pressure and temperature are again applied to the mold. According to embodiments, the degassing step is performed at least twice during the formation of a single inventive composite sandwich panel 10 with a decorative vehicle interior paint layer 29 applied to the structural skin 16. An exemplary profile curve is detailed in FIG. 9.

According to embodiments, the compression molding and/or vacuum molding steps bring the edges of the high gloss surface sheet 14 and the structural skin 16 together along at least one edge of the composite sandwich panel assembly 10 to form a seal along the edge. According to embodiments, at least one of the high gloss surface sheets 14 and the structural skin 16 is preformed such that it has edges extending generally perpendicularly from the plane of the sheet material, this edge providing sufficient material such that the edges of the high gloss surface sheet 14 and the structural skin 16 can be joined together.

Excess material is removed from the edges after the seal is formed between the high gloss surface sheet 14 and the structural skin 16 with resort to a trimming tool conventional to the art.

The foregoing description is illustrative of particular embodiments of the invention but is not meant to be a limitation upon the practice thereof. The following claims, including all equivalents thereof, are intended to define the scope of the invention.

1. A composite sandwich panel assembly, the assembly comprising:
a lightweight core having a first face and a second face opposing the first face;
a high gloss surface sheet adhered to the first face of the lightweight core by a first adhesive layer, the high gloss surface sheet having a high gloss surface;
a structural skin adhered to the second face of the lightweight core by a second adhesive layer; and
a paint layer disposed on an exposed surface of the structural skin, the layer exhibiting optical uniformity over at least 80% of the surface area of the layer.

2. The assembly of claim 1 wherein the paint layer is formed of precursors of: polyurethanes, latexes, epoxies, polyureas, polyacrylates, or block co-polymers in which any of the aforementioned constitute at least 20 percent of the total number of subunits.

3. The assembly of claim 1 wherein the paint layer imparts a color to the structural skin and the structural skin has surface texture that is not smooth or is entirely opaque across at least 80% of the surface area of the layer.

4. The assembly of claim 1 wherein the paint layer is applied to the exposed surface of the structural skin in a mold during formation of the composite sandwich panel assembly.

5. The assembly of claim 1 further comprising a veil positioned between the structural skin and the layer.

6. The assembly of claim 5 wherein the veil is pre-painted.

7. The assembly of claim 1 wherein the lightweight core is formed of at least one of: cellulosics, thermoplastic, thermoset, metal, or foam.

8. The assembly of claim 1 wherein the high gloss surface sheet is formed of any one of: sheet molding compound (SMC), thermoplastic sheet, dicyclopentadiene (DCPD), or overmolded polyurethane (PU) and optionally comprises a filler.

9. The assembly of claim 1 wherein the high gloss surface sheet has a thickness of from 0.5 to 3.5 mm and optionally has a ratio of a thickness of the high gloss surface sheet to a thickness of the lightweight core of 0.01-1:1.

10. The assembly of claim 1 wherein further comprising a cloth intermediate between the high gloss surface sheet and the lightweight core and is optionally embedded in the first adhesive paint layer and the high gloss surface sheet is an SMC that has a thickness of less than 1.5 mm and still retains the high gloss surface.

11. The assembly of claim 1 further comprising a decorative layer attached to the structural skin.

12. The assembly of claim 1 wherein the high gloss surface sheet and the structural skin are joined together to form an edge defining a moisture resistant seal and optionally includes a gasket disposed between the high gloss surface sheet and the first structural at the edge.

13. The assembly of claim 1 wherein the paint layer includes at least one of a UV stabilizer, a mica material, a phosphorescent material, a felted material, or a rubberized material felt.

14. The assembly of claim 1 wherein the lightweight core has at least one of a fastener, a duct, a conduit, or a wire, embedded at least partially therein.

15. A process for forming a composite sandwich panel assembly, the process comprising:
applying paint layer precursors to a surface of a mold in which the composite sandwich panel assembly is to be formed and allowing the paint layer precursors to at least partially cure to form a layer;
positioning an exposed surface of a structural skin in the mold on the layer;
joining a first face of a lightweight core to a surface of the structural skin that is opposite the paint layer with a first adhesive layer intermediate therebetween;
joining a high gloss surface sheet to a second face opposing the first face of the lightweight core with a second adhesive layer intermediate therebetween to form the composite sandwich panel assembly.

16. The process of claim 15 further comprising applying a mask to the surface of the mold prior to applying the paint layer precursors to the surface of the mold.

17. The process of claim 15 further comprising vacuum molding the composite sandwich panel assembly.

18. The process of claim 15 further comprising removing excess material from the structural skin proximal to the edge.

19. The process of claim 15 wherein the composite sandwich panel assembly is formed in the mold at a temperature between 200 and 250 degrees F. or a pressure between 60 and 70 psi.

20. The process of claim 15 further comprising opening the mold at least once during formation of the composite sandwich panel assembly to vent off gases.
